(19) United States
(12) Patent Application Publication
(10) Pub. No.: US 2021/0237736 A1
(43) Pub. Date: Aug. 5, 2021

(54) Method For The At Least Partly Automated Guidance Of A Motor Vehicle

(71) Applicants: Robert Bosch GmbH, Stuttgart-Feuerbach (DE); Daimler AG, Stuttgart (DE)

(72) Inventors: Christoph Gustav Keller, Stuttgart (DE); Holger Mielenz, Ostfildern (DE)

(73) Assignees: Robert Bosch GmbH, Stuttgart-Feuerbach (DE); Daimler AG, Stuttgart (DE)

(21) Appl. No.: 17/238,640

(22) Filed: Apr. 23, 2021

Related U.S. Application Data
(63) Continuation of application No. PCT/EP2019/073678, filed on Sep. 5, 2019.

(30) Foreign Application Priority Data
Oct. 23, 2018 (DE) 102018126295.7

(51) Int. Cl. B60W 30/18; B60W 60/00; B60W 30/12

(52) U.S. Cl. CPC B60W 30/18159; B60W 60/001; B60W 30/12; B60W 2552/53; B60W 2554/4026; B60W 2554/4049; B60W 30/18145

(57) ABSTRACT

A method for the at least partially automated guidance of a motor vehicle includes receiving a plurality of surroundings signals which represent an area surrounding the motor vehicle and, when a turning situation is present in which the motor vehicle is to turn at an intersection point, generating a plurality of control signals for the at least partially automated control of a lateral and longitudinal guidance of the motor vehicle on the basis of the surroundings signals. The method includes outputting the control signals to guide the motor vehicle on the basis of the control signals to, before a turning maneuver, guide the motor vehicle at a reduced lateral distance from a lane edge that is on an inside of a bend corresponding to the turning maneuver, to impede or prevent overtaking by a two-wheeled vehicle on a side of the motor vehicle on the inside of the bend.

### CROSS-REFERENCE TO RELATED APPLICATIONS

This application is a continuation of PCT International Application No. PCT/EP2019/073678, filed on Sep. 5, 2019, which claims priority under 35 U.S.C. § 119 to German Patent Application No. 102018126295.7, filed on Oct. 23, 2018.

### FIELD OF THE INVENTION

The present invention relates to a motor vehicle and, more particularly, to a method for the at least partially automated guidance of a motor vehicle.

### BACKGROUND

In road traffic, situations can occur in which a two-wheeled vehicle travels into an intermediate space between a motor vehicle which is turning and a lane edge which is on the inside of a bend corresponding to the turn. Such an intermediate space can be difficult to see. This can increase the risk of an accident for the two-wheeled vehicle.

U.S. Patent Application Publication No. 2018/0001952 A1 discloses a concept for detecting a possible collision of a motor vehicle with a two-wheeled vehicle. At least partially automated guidance of a motor vehicle is needed that can efficiently reduce the risk of an accident for a two-wheeled vehicle due to a turning maneuver of a motor vehicle.

### SUMMARY

A method for the at least partially automated guidance of a motor vehicle includes receiving a plurality of surroundings signals which represent an area surrounding the motor vehicle and, when a turning situation is present in which the motor vehicle is to turn at an intersection point, generating a plurality of control signals for the at least partially automated control of a lateral and longitudinal guidance of the motor vehicle on the basis of the surroundings signals. The method includes outputting the control signals to guide the motor vehicle on the basis of the control signals to, before a turning maneuver, guide the motor vehicle at a reduced lateral distance from a lane edge that is on an inside of a bend corresponding to the turning maneuver, to impede or prevent overtaking by a two-wheeled vehicle on a side of the motor vehicle on the inside of the bend.

### BRIEF DESCRIPTION OF THE DRAWINGS

Exemplary embodiments of the invention are illustrated in the drawings and explained in more detail in the following description. In the drawings:

FIG. 1 is a flow diagram of a method for the at least partially automated guidance of a motor vehicle;

FIG. 2 is a schematic diagram of a device according to an embodiment configured to carry out the method of FIG. 1;

FIG. 3 is a schematic diagram of a motor vehicle according to an embodiment having the device of FIG. 2;

FIG. 4 is a schematic diagram of a machine-readable storage medium storing instructions for performing the method of FIG. 1;

FIG. 5 is a schematic diagram of a turning situation for a motor vehicle and a two-wheeled vehicle; and

FIG. 6 is a schematic diagram of a turning situation for the motor vehicle of FIG. 3 and a two-wheeled vehicle.

### DETAILED DESCRIPTION OF THE EMBODIMENT(S)

The wording “at least partially automated control” throughout the description herein comprises the following cases: partially automated control guidance, highly automated control guidance, fully automated control guidance, driverless control guidance, and remote-control of the motor vehicle.

Partially automated control guidance means that longitudinal and lateral guidance of the motor vehicle are controlled automatically in a specific application case (for example: driving on a freeway, driving within a car park, overtaking an object, driving within a lane which is defined by lane markings). A driver of the vehicle does not have to manually control the longitudinal and lateral guidance of the motor vehicle. However, the driver must continuously monitor the automatic control of the longitudinal and lateral guidance in order to be able to intervene manually when necessary.

Highly automated control guidance means that longitudinal and lateral guidance of the motor vehicle are controlled automatically in a specific application case (for example: driving on a freeway, driving within a car park, overtaking an object, driving within a lane which is defined by lane markings). A driver of the motor vehicle does not have to manually control the longitudinal and lateral guidance of the motor vehicle. The driver does not have to continuously monitor the automatic control of the longitudinal and lateral guidance in order to be able to intervene manually when necessary. When necessary, a takeover request is automatically issued to the driver to take over the control of the longitudinal and lateral guidance. The driver must therefore potentially be able to take over the control of the longitudinal and lateral guidance.

Fully automated control guidance means that longitudinal and lateral guidance of the motor vehicle are controlled automatically in a specific application case (for example: driving on a freeway, driving within a car park, overtaking an object, driving within a lane which is defined by lane markings). A driver of the motor vehicle does not have to manually control the longitudinal and lateral guidance of the motor vehicle. The driver does not have to monitor the automatic control of the longitudinal and lateral guidance in order to be able to intervene manually when necessary. The driver is not necessary in the specific application case.

Driverless control guidance means that longitudinal and lateral guidance of the motor vehicle are controlled automatically irrespective of a specific application case (for example: driving on a freeway, driving within a car park, overtaking an object, driving within a lane which is defined by lane markings). A driver of the motor vehicle does not have to manually control the longitudinal and lateral guidance of the motor vehicle. The driver does not have to monitor the automatic control of the longitudinal and lateral guidance in order to be able to intervene manually when necessary. The longitudinal and lateral guidance of the motor vehicle are therefore controlled automatically, for example, on all road types, in all speed ranges and under all environmental conditions. The entire driving function of the driver is therefore performed automatically. The driver is therefore no longer necessary. The motor vehicle can therefore even drive from any desired starting position to any desired destination position without a driver. Potential problems are solved automatically, that is to say without the assistance of the driver.

Remote control of the motor vehicle means that the lateral and longitudinal guidance of the motor vehicle are remote-controlled. This means, for example, that remote control signals for performing remote control of the longitudinal and lateral guidance are transmitted to the motor vehicle. The remote control is carried out, for example, by a remote control apparatus at a distance.

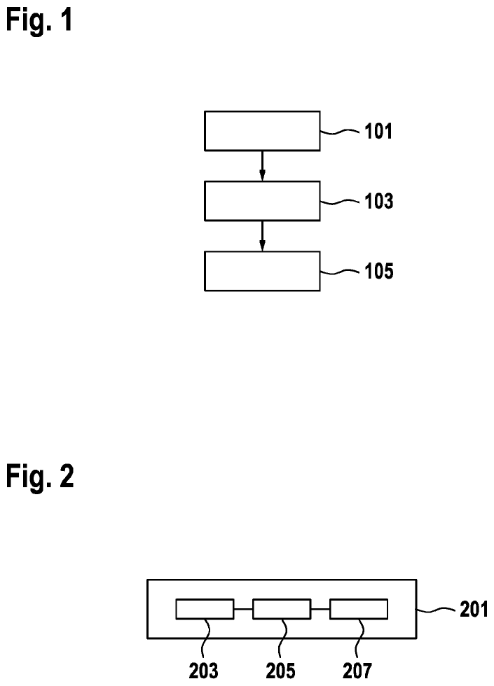

FIG. 1 shows a flow diagram of a method for the at least partially automated guidance of a motor vehicle.

The method shown in FIG. 1 includes receiving 101 surroundings signals which represent an area surrounding the motor vehicle. Surroundings signals comprise, according to one embodiment, surroundings sensor signals of a surroundings sensor system of the motor vehicle. A surroundings sensor system of the motor vehicle comprises, according to one embodiment, one or more surroundings sensors. A surroundings sensor is, for example, one of the following surroundings sensors: radar sensor, ultrasonic sensor, lidar sensor, infrared sensor, magnetic field sensor and video sensor. Surroundings signals comprise, according to one embodiment, map signals of a digital map of an area surrounding the motor vehicle.

When a turning situation is present in which the motor vehicle is to turn at an intersection point, the method shown in FIG. 1 includes generating 103 control signals for the at least partially automated control of lateral and longitudinal guidance of the motor vehicle on the basis of the surroundings signals. In the case of at least partially automated control of the lateral and longitudinal guidance of the motor vehicle on the basis of the generated control signals, the motor vehicle is guided, before the turning maneuver, at a reduced lateral distance of the motor vehicle from a lane edge which is on the inside of the bend and corresponds to the turning maneuver, in order to impede or prevent overtaking by a two-wheeled vehicle on a side of the motor vehicle on the inside of the bend. Turning is understood in particular to mean a change in the direction of travel to the left or right at the intersection point 501. The direction indications “left” and “right” relate to a direction of travel of the motor vehicle 301.

A two-wheeled vehicle denotes in particular a single-track vehicle, for example a motor vehicle with two wheels. A two-wheeled vehicle is, for example, an element from the following group of two-wheeled vehicles: a motorized two-wheeled vehicle such as for example a moped, small motorbike, electric bicycle, lightweight motorbike, motor scooter, motorbike, and a non-motorized two-wheeled vehicle such as for example a bicycle, for example bicycle with stabilizer wheels, and a pedal scooter. If the singular is used for the two-wheeled vehicle, this should always be understood as covering the plural, and vice versa.

The method shown in FIG. 1 includes outputting 105 the generated control signals in order to guide the motor vehicle in an at least partially automated fashion on the basis of the generated control signals.

A device 201 according to an embodiment is shown in FIG. 2. The device 201 is configured to carry out all the steps of the method according to the first aspect shown in FIG. 1. The device 201 has an input 203 which is configured to receive surroundings signals, as described above and/or below. The device 201 also has a processor 205 which is configured to generate control signals, as described above and/or below. In one embodiment, a plurality of processors are provided instead of the one processor 205. According to one embodiment, the processor 205 is configured to process surroundings signals in order to detect a two-wheeled vehicle in a surrounding area to the rear of the motor vehicle, as described above and/or below. The device 201 also has an output 207 which is configured to output the generated control signals, as described above and/or below.

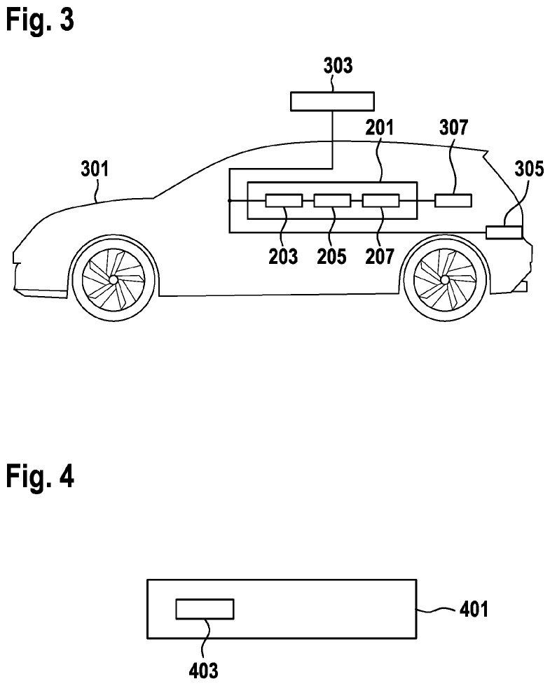

A motor vehicle 301 according to an embodiment is shown in FIG. 3. The motor vehicle 301 comprises the device 201 according to FIG. 2. A motor vehicle 301 according to the description is, for example, a shuttle, a car, a robot taxi (Robotaxi) or a utility vehicle. The motor vehicle 301 has a roof-mounted video camera 303 including a video sensor. The roof-mounted video camera 303 is, for example, a 360° video camera. The roof-mounted video camera 303 captures, for example, an area to the rear, such as a surrounding area to the rear of the motor vehicle 301.

As shown in FIG. 3, the motor vehicle 301 has a radar sensor 305 arranged at the rear, on a rear side on the motor vehicle. The radar sensor 305 senses a surrounding area to the rear of the motor vehicle 301. The video camera 303 and the radar sensor 305 therefore form a surroundings sensor system of the motor vehicle 301. The motor vehicle 301 also has a control apparatus 307.

Video signals (surroundings signals) of the video camera 303 and radar signals (surroundings signals) of the radar sensor 305, which represent an area which is correspondingly sensed to the rear, a surrounding area which is correspondingly sensed to the rear, of the motor vehicle 305, are provided to the input 203; the input 203 receives the video signals and the radar signals. The processor 205 generates, as described above and/or below, corresponding control signals when a turning situation is present. The output 207 outputs the generated control signals to the control apparatus 307. The control apparatus 307 controls the lateral and longitudinal guidance of the motor vehicle 301 on the basis of the control signals which are output, in order to guide the motor vehicle in an at least partially automated fashion on the basis of the control signals which are output.

A machine-readable storage medium 401 according to an embodiment is shown in FIG. 4. The machine-readable storage medium 401 is a non-transitory computer readable medium. A computer program 403 is stored in the machine-readable storage medium 401. The computer program 403 comprises instructions which, when the computer program 403 is run by a computer, for example by the device 201, cause the computer or device to carry out a method according to the first aspect shown in FIG. 1.

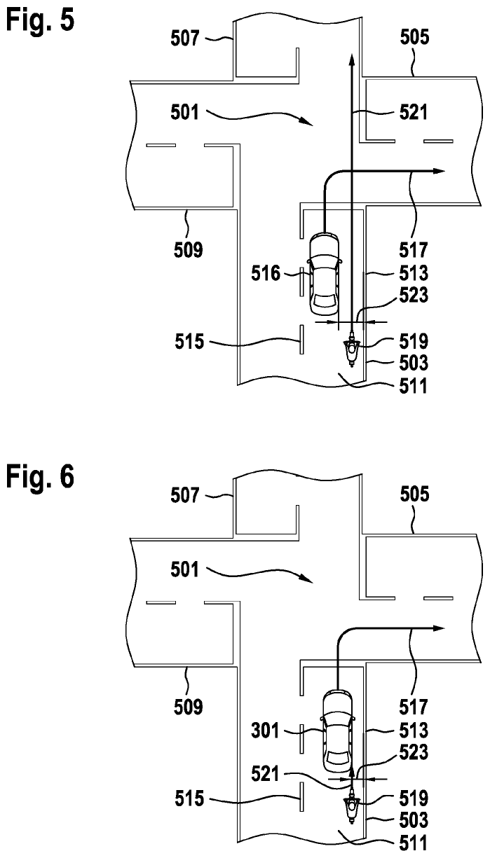

FIG. 5 shows a junction 501 as an exemplary intersection point. Four roads intersect at the junction 501: a first road 503, a second road 505, a third road 507, and a fourth road 509. A motor vehicle 516 is traveling in a lane 511 of the first road 503. A lane 511 denotes, in particular, an area which is available to a motor vehicle 516 for travel in one direction. A lane 511 is characterized, for example, by road markings that comprise, for example, a boundary of a roadway, a boundary of a lane and/or a guiding line. However, a lane 511 does not necessarily have to be characterized by road markings; the lane 511 can also be free of road markings. The lane 511 in the shown embodiment is marked on a left-hand side by a dashed lane marking 515 and on a right-hand side by a continuous lane line 513, also referred to as a right-hand lane marking 513. An intersection point in various embodiments can be any location at which a plurality of traffic paths of the same type intersect; an intersection point is, for example, a junction or a T junction.

The motor vehicle 516 wishes to turn to the right from the first road 503 onto the second road 505 in the exemplary embodiment shown in FIGS. 5 and 6. A target turning trajectory for the motor vehicle 516 is represented by an arrow 517. A two-wheeled vehicle 519 is located in a surrounding area to the rear of the motor vehicle 516. The two-wheeled vehicle 519 is located in the lane 511 to the rear of the motor vehicle 516. The two-wheeled vehicle 519 is located at the right-hand continuous lane line 513 and wishes to travel straight ahead over the junction 501. A corresponding future trajectory of the two-wheeled vehicle 519 is illustrated with an arrow 521.

A distance, which is characterized by a double arrow with the reference symbol 523 in FIG. 5, is formed between the right-hand lane marking 513 and the motor vehicle 516. The distance 523 is such that the two-wheeled vehicle 519 could still overtake the motor vehicle 516 to the right. However, when the motor vehicle 516 turns, this can possibly lead to a collision with the two-wheeled vehicle 519.

FIG. 6 shows the turning situation shown in FIG. 5, now not for the motor vehicle 516 but rather for the motor vehicle 301 according to FIG. 3. According to the concept described here there is provision that, in such a turning situation, the motor vehicle 301 reduces the distance 523 so that overtaking of the motor vehicle 301 by the two-wheeled vehicle 519 is impeded or even prevented. After the method according to the invention has been carried out, a formerly present free space, also referred to as an intermediate space, is no longer present or is at least reduced to such an extent that the two-wheeled vehicle 519 can no longer overtake the motor vehicle 301 to the right. As result, critical situations when the motor vehicle 301 turns can therefore be efficiently avoided.

According to one embodiment, it is determined that a turning situation is present if travel direction indicator signals which represent an activation of a travel direction indicator of the motor vehicle 301 are received. According to one embodiment, route signals are received which represent a future route of the motor vehicle 301, wherein the route signals are processed in order to detect the presence of a turning situation, so that when a turning situation is detected it is determined that a turning situation is present.

In one embodiment, a determination of lane 511 profiles is provided on the basis of a digital map and/or sensing of the surroundings using a surroundings sensors system. According to one embodiment there is provision that, on the basis of the determined lane 511 profiles, a turning behavior is calculated for the motor vehicle 301 on the basis of a destination specification (which can be included, for example, in a future route of the motor vehicle 301), wherein the calculation is carried out, for example, using a routing method.

According to one embodiment there is provision that a present position of the motor vehicle 301 relative to the present lane 511 on which the motor vehicle 301 is presently located is sensed.

According to one embodiment, static and/or dynamic objects in the surroundings are detected, for example using the sensing of the surroundings via the surroundings sensor system 303, 305 and/or using a digital map having map signals (which can generally also be referred to as map data). A digital map of an area surrounding the motor vehicle 301 according to the description represents, for example, one or more static objects in the surroundings and/or one or more dynamic objects in the surroundings of the motor vehicle 301. A dynamic object in the surroundings is, for example, one of the following objects in the surroundings: motor vehicle, two-wheeled vehicle, pedestrian. A static object in the surroundings is, for example, one of the following static objects in the surroundings: infrastructure element such as, for example, a building, a traffic signal, a lamp post and a power pole, a tree. A digital map of the area surrounding the motor vehicle 301 shows for example roads and/or intersection points, in particular the intersection point 501 at which the motor vehicle is to turn.

According to one embodiment, the target turning trajectory 517 is determined for the motor vehicle 301. The determination is, for example, carried out on the basis of the sensed position and/or on the basis of the determined objects in the surroundings.

According to one embodiment, a lateral position of the target turning trajectory 517 is configured in such a way that a lateral distance from the lane edge 513 on the inside of the bend undershoots a predetermined distance threshold value, so that it is no longer possible for a two-wheeled vehicle 519 to overtake the motor vehicle 301 on the side on the inside of the bend (which corresponds to the guidance at a reduced lateral distance, as described here). The predetermined distance threshold value depends, for example, on a width of normally two two-wheeled vehicles. For example, the predetermined distance threshold value is less than or equal to one meter, for example less than or equal to 0.5 m, for example less than or equal to 0.3 m, for example less than or equal to 0.2 m.

According to one embodiment, a control apparatus is provided which is configured to adjust the calculated target turning trajectory 517.

The concept described here can be used for both left-hand and right-hand turning maneuvers. When the motor vehicle 301 turns to the left with respect to a direction of travel of the motor vehicle 301, the side of the motor vehicle 301 on the inside of the bend is the left-hand side, and the lane edge on the inside of the bend is the left-hand lane edge. In the case of turning to the right with respect to a direction of travel of the motor vehicle 301, the side of the motor vehicle 301 on the inside of the bend is the right-hand side of the motor vehicle 301, and the lane edge on the inside of the bend is the right-hand lane edge. Furthermore, the concept described here can also be applied to continuous turning processes and also to turning processes with prior braking to a standstill. This can be the case, for example, at a traffic signal which is emitting a red light signal.

In one embodiment, the concept described here is applied only when a situation is present in which a two-wheeled vehicle 519 has been detected to the rear of the motor vehicle 301. This advantageously has the effect that the motor vehicle 301 does not travel along the lane edge 513 on the inside of the bend in every turning situation, even if there is no two-wheeled vehicle 519 present to the rear of the motor vehicle 301.

In one embodiment, the surroundings signals are processed in order to detect a two-wheeled vehicle 519 in a surrounding area to the rear of the motor vehicle 301, wherein the control signals are generated and output as a function of a detection of a two-wheeled vehicle 519 in the surrounding area to the rear of the motor vehicle 301. This provides, for example, the technical advantage that the motor vehicle 301 can be guided efficiently as a function of the presence of a two-wheeled vehicle 519.

In one embodiment, when a two-wheeled vehicle 519 is detected in the surrounding area to the rear of the motor vehicle 301, a movement of the detected two-wheeled vehicle 519 is predicted in order to determine whether the detected two-wheeled vehicle 519 will be located on the side of the motor vehicle 301 on the inside of the bend at an anticipated turning time, wherein the control signals are generated and output if the two-wheeled vehicle 519 will be located on the side of the motor vehicle 301 on the inside of the bend at the anticipated turning time. This provides, for example, the technical advantage that the motor vehicle 301 can be guided efficiently as a function of the anticipated turning time.

According to one embodiment, when a two-wheeled vehicle 519 is detected in the surrounding area to the rear of the motor vehicle 301, a movement of the detected two-wheeled vehicle 519 is predicted in order to determine whether the detected two-wheeled vehicle 519 will be located on the side of the motor vehicle 301 on the inside of the bend at an anticipated turning time, wherein the control signals are generated and output only when the two-wheeled vehicle 519 will be located on the side of the motor vehicle 301 on the inside of the bend at the anticipated turning time. This provides, for example, the technical advantage that the motor vehicle 301 is guided at the reduced lateral distance only when such guidance is necessary, that is to say if there is also actually a risk of being overtaken by a two-wheeled vehicle 519.

According to one embodiment, when a stopping situation is present in which the motor vehicle 301 must stop before the turning maneuver, the generated control signals comprise control signals for the at least partially automated control of the lateral and longitudinal guidance of the motor vehicle 301, with the aim that, in the case of at least partially automated control of the lateral and longitudinal guidance of the motor vehicle 301 on the basis of the generated control signals, the motor vehicle 301 is stopped before the turning maneuver at the reduced lateral distance of the motor vehicle 301 from the lane edge 513 on the inside of the bend. This provides, for example, the technical advantage of being able to efficiently impede or avoid a two-wheeled vehicle 519 traveling into an intermediate space between the lane edge 513 on the inside of the bend and the motor vehicle 301.

In one embodiment, statistical information from a digital map which provides information about a probability of the occurrence of a two-wheeled vehicle 519 at the intersection point or junction 501 at the present time is used to generate the control signals. For example, there is provision that the control signals are generated and output only when the probability is higher than or higher than or equal to a predetermined probability threshold value.

Advantages of the concept described here are, in particular, a reduction in the risk of a collision of a motor vehicle 301 with a two-wheeled vehicle 519 during a turning process. Advantages of the concept described here are, in particular, an increase in customer value of the behavior of a motor vehicle 301 through an avoidance of challenging situations for behavior planning arising from two-wheeled vehicles 519 which are located/travelling in parallel.

What is claimed is:

1. A method for the at least partially automated guidance of a motor vehicle, comprising:
receiving a plurality of surroundings signals which represent an area surrounding the motor vehicle;
when a turning situation is present in which the motor vehicle is to turn at an intersection point, generating a plurality of control signals for the at least partially automated control of a lateral and longitudinal guidance of the motor vehicle on the basis of the surroundings signals; and
outputting the control signals to guide the motor vehicle on the basis of the control signals to, before a turning maneuver, guide the motor vehicle at a reduced lateral distance from a lane edge that is on an inside of a bend corresponding to the turning maneuver to impede or prevent overtaking by a two-wheeled vehicle on a side of the motor vehicle on the inside of the bend.

2. The method of claim 1, wherein the reduced lateral distance is less than or equal to a predetermined distance threshold value.

3. The method of claim 1, wherein the surroundings signals are processed in order to detect the two-wheeled vehicle in a surrounding area to a rear of the motor vehicle.

4. The method of claim 3, wherein the control signals are generated and output as a function of a detection of the two-wheeled vehicle in the surrounding area.

5. The method of claim 4, wherein, when the two-wheeled vehicle is detected in the surrounding area, a movement of the two-wheeled vehicle is predicted to determine whether the two-wheeled vehicle will be located on the side of the motor vehicle on the inside of the bend at an anticipated turning time.

6. The method of claim 5, wherein the control signals are generated and output if the two-wheeled vehicle will be located on the side of the motor vehicle on the inside of the bend at the anticipated turning time.

7. The method of claim 1, wherein, when a stopping situation is present in which the motor vehicle must stop before the turning maneuver, the motor vehicle is stopped according to the control signals before the turning maneuver at the reduced lateral distance of the motor vehicle from the lane edge on the inside of the bend.

8. The method of claim 4, wherein, when a stopping situation is present in which the motor vehicle must stop before the turning maneuver, the motor vehicle is stopped according to the control signals before the turning maneuver at the reduced lateral distance of the motor vehicle from the lane edge on the inside of the bend.

9. The method of claim 6, wherein, when a stopping situation is present in which the motor vehicle must stop before the turning maneuver, the motor vehicle is stopped according to the control signals before the turning maneuver at the reduced lateral distance of the motor vehicle from the lane edge on the inside of the bend.

10. The method of claim 1, wherein the surroundings signals include a plurality of map signals of a digital map, the map signals represent a statistical probability of a presence of the two-wheeled vehicle at the intersection point, the control signals are generated on the basis of the map signals.

11. The method of claim 4, wherein the surroundings signals include a plurality of map signals of a digital map, the map signals represent a statistical probability of a presence of the two-wheeled vehicle at the intersection point, the control signals are generated on the basis of the map signals.

12. The method of claim 6, wherein the surroundings signals include a plurality of map signals of a digital map, the map signals represent a statistical probability of a presence of the two-wheeled vehicle at the intersection point, the control signals are generated on the basis of the map signals.

13. The method of claim 7, wherein the surroundings signals include a plurality of map signals of a digital map, the map signals represent a statistical probability of a presence of the two-wheeled vehicle at the intersection point, the control signals are generated on the basis of the map signals.

14. A device, comprising:
an input receiving a plurality of surroundings signals which represent an area surrounding a motor vehicle;
a processor generating, when a turning situation is present in which the motor vehicle is to turn at an intersection point, a plurality of control signals for an at least partially automated control of a lateral and longitudinal guidance of the motor vehicle on the basis of the surroundings signals; and
an output outputting the control signals to guide the motor vehicle on the basis of the control signals to, before a turning maneuver, guide the motor vehicle at a reduced lateral distance from a lane edge that is on an inside of a bend corresponding to the turning maneuver to impede or prevent overtaking by a two-wheeled vehicle on a side of the motor vehicle on the inside of the bend.

15. A computer program embodied on a machine-readable storage medium that, when executed by a computer, causes the computer to perform the steps of:
receiving a plurality of surroundings signals which represent an area surrounding a motor vehicle;
when a turning situation is present in which the motor vehicle is to turn at an intersection point, generating a plurality of control signals for an at least partially automated control of a lateral and longitudinal guidance of the motor vehicle on the basis of the surroundings signals; and
outputting the control signals to guide the motor vehicle on the basis of the control signals to, before a turning maneuver, guide the motor vehicle at a reduced lateral distance from a lane edge that is on an inside of a bend corresponding to the turning maneuver to impede or prevent overtaking by a two-wheeled vehicle on a side of the motor vehicle on the inside of the bend.
